(19) United States
(12) Patent Application Publication
(10) Pub. No.: US 2008/0120270 A1
(43) Pub. Date: May 22, 2008

(54) DATABASE SYSTEM

(75) Inventor: Johan Hugo LAMBERTS, OISTERWIJK (NL)

Correspondence Address: THORNE & HALAJIAN;APPLIED TECHNOLOGY CENTER, 111 WEST MAIN STREET, BAY SHORE, NY, 11706, US

(73) Assignee: LLINXX, OISTERWIJK (NL)

(21) Appl. No.: 11/941,991

(22) Filed: Nov. 19, 2007

(30) Foreign Application Priority Data
Nov. 17, 2006 (EP) 06124305.1

(51) Int. Cl. G06F 17/30

(52) U.S. Cl. 707/1

(57) ABSTRACT

A database system includes receiving, storing and retrieving data using the following database elements: an item element comprising database data; a link element comprising a link between the item element and a further item element; an item type element comprising type information of the item element; and a link type element comprising type information of the link element. The item element has a type field for connecting to an item type element, and the link element comprising a type field for connecting to a link type element. In each database element an actual timestamp is included. For retrieving an actual version of the database element, the timestamps are evaluated and the most recent database element is retrieved. Using the above four basic database elements and the timestamp advantageously allows entering data without prior design of a database structure, and modifying both data and links on the fly using the time stamps for keeping consistency.

### FIELD OF THE INVENTION

The invention relates to a method of managing data in a database in a database system.

The invention further relates to a database system for managing data in a database, the system comprising input means for receiving database data to be stored, processing means for processing the database data, and storage means for storing and retrieving database data.

The invention further relates to computer program product for managing data in a database according to the method.

### BACKGROUND OF THE INVENTION

Database systems are known in various forms. Usually database systems are based on relational database technology. The development of object oriented programming languages also resulted in a generation of database systems based on the object model. Further development used natural concepts as objects and roles in a system called Object-Role Modeling, a fact oriented method for performing information analysis at the conceptual level. An introduction can be found in the document “Object-Role Modeling: An overview”, by Terry Halpin, Microsoft Corporation.

Document U.S. Pat. No. 6,163,776, incorporated herein by reference, describes a system for managing data and exchanging data and commands between an object oriented system and a relational system. The system includes an Object-Relational mapping grammar and specification, object class definitions, a relational database and various other units. Data is modeled in various tables having a set of attributes for each record, which tables are subsequently linked and managed, for example as shown in FIG. 19 thereof.

However, a problem of the known database systems is that a careful design of the database is required prior to data entry, such as the layout of tables, relations and/or objects which usually involve a database expert.

### SUMMARY OF THE INVENTION

It is an object of the invention to provide a method and system for managing data in a database that does not require a database design at expert level, and allows flexible storage of, and creation of structure in, a user data collection.

For this purpose, according to a first aspect of the invention, the method of managing data in a database as described in the opening paragraph comprises receiving database data to be stored, generating at least one database element out of the following database elements:
an item element comprising database data;
a link element comprising a link between the item element and a further item element;
an item type element comprising type information of the item element;
a link type element comprising type information of the link element; the item element comprising a type field for connecting to an item type element, the link element comprising a type field for connecting to a link type element, including an actual timestamp in the database element and subsequently storing the database element, and retrieving an actual version of the database element in dependence of the timestamp.

For this purpose, according to a further aspect of the invention, in the database system as described in the opening paragraph, the processing means are arranged for generating at least one database element out of the following database elements:
an item element comprising database data;
a link element comprising a link between the item element and a further item element;
an item type element comprising type information of the item element;
a link type element comprising type information of the link element; the item element comprising a type field for connecting to an item type element, the link element comprising a type field for connecting to a link type element, and including an actual timestamp in the database element, and the storage means are arranged for, subsequent to including said actual timestamp, storing the database element and for retrieving database elements, and the processing means are arranged for selecting an actual version of the database element in dependence of the timestamp.

The measures have the following effect. In the database the data itself is stored in the item elements, whereas the structure and interrelation between data, i.e. between item elements, is stored in the link elements. The item type elements and link type elements provide a higher level in the database, and comprise information defining the respective type of the lower level item elements and link elements. As each database element only stores a single chunk of user data, there is no restriction to including further user data. New user data of an existing type is stored in new item elements according to the known item type. New links and further user data connected to earlier user data are stored in new link elements and further item elements. New link type elements may be added at any time, allowing modifications of the database structure while entering data. Advantageously no design of a database structure is required as a prerequisite before user data, and relations between user data, can be received and stored. Moreover, as each database element is provided with an actual time stamp, an actual version of any database element can be retrieved. Advantageously any modification of a database element can be traced back, and undone, if necessary.

The invention is also based on the following recognition. From the prior art use of database systems it may be known to identify a structure of the user data of the application area, and building a formal model. Object-Role Modeling may simplify the design process by using natural language and intuitive diagrams which can be populated with examples. The inventor has seen that the step of modeling can be substantially eliminated by directly providing the four basic database elements as defined above. The database elements can immediately be used for storing data and relations without a preceding modeling phase, and the structure of the data in the database can easily be extended by adding further link elements and like type elements. Including the timestamp in each database element allows updating of any element, and enables tracing and undoing any change in the database contents or structure.

In an embodiment the method generating the database element comprises including an identifier that identifies the database element and enables further database elements to connect to the respective database element, the identifier in combination with the timestamp constituting a unique key for the database element. The identifier provides a direct way of accessing any database element. An amended version of a database element has the same identifier, but a new time stamp. Hence the combination of identifier and time stamp provides a unique key for the database element. In particular, said retrieving of the actual version of the database element involves selecting a most recent one of all database elements having a same identifier. This has the advantage that multiple versions of the database element may be present in the database, whereas the most recent one, i.e. the valid version, can be selected by evaluating the time stamp.

In an embodiment of the method generating said link element comprises including a position field indicating a position with respect to further link elements of a same link type, and/or generating said link type element comprises including a position field indicating a position with respect to further link type elements, and the method comprises ordering item elements and/or item type elements according to the position. The position field is added to the link element or link type element. Advantageously, when entering, presenting or displaying user data from the item elements, the order of the user data is arranged according to the position field. This has the advantage that the data input of output is ordered according to a logical sequence defined by the position fields for the user.

In an embodiment the method comprises providing a copy of the database in a further database system, operating for a period the database and the copy of the database simultaneously and independently, and synchronizing, after said period of operating, the database and the copy of the database in dependence of the timestamps. Synchronizing requires that updates to both the main version and copy of the database are combined. Due to the timestamps any changes or additions to the database in either the main version or the copy can be put in a sequential order, and possible conflict can be resolved. Advantageously when related fields are modified in both copies, due to the singular structure of the item elements, synchronization is substantially easier compared to relational databases having complex records having many fields.

Further preferred embodiments of the method, the database system and computer program product according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a database system for managing data in a database,

FIG. 2 shows a method of storing data in a database,

FIG. 3 shows a method of retrieving data from a database,

FIG. 4 shows a data model,

FIG. 5 shows diagram of a database,

FIG. 6 shows a data model without specifying a link, and

FIG. 7 shows a data model which specifies a link on item level.

### Corresponding elements in different Figures may have identical reference numerals.

### DETAILED DESCRIPTION OF EMBODIMENTS

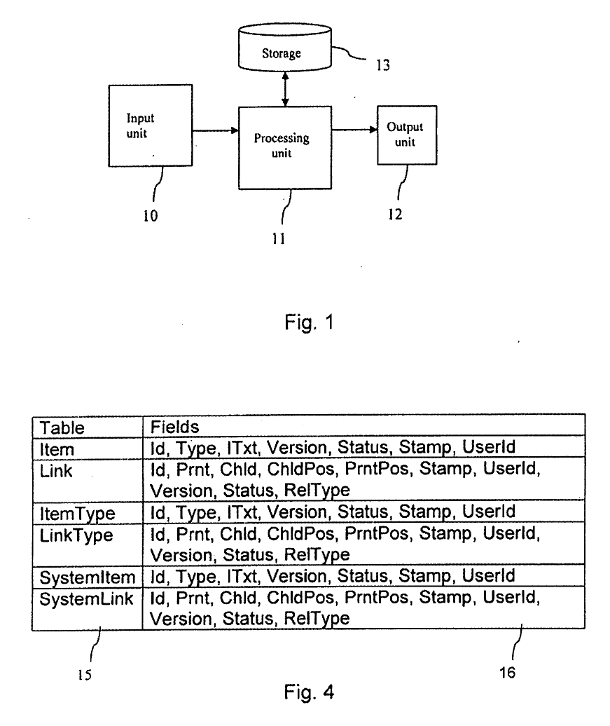

FIG. 1 shows a database system for managing data in a database. The system has an input unit 10 for receiving database data to be stored, for example a user input device having a keyboard, mouse and display. It is noted that database data may be received from any source, or multiple sources, as a known as such in the field of data processing. The database system further has a processing unit 11 discussed below, and an output unit 12 for providing data from the database to the user, e.g. a display for presenting data, or any other output system, such as printout on paper, of a structured data collection on a storage medium like an optical disc. Furthermore the system has a storage system 13 for storing and retrieving database data, e.g. suitable mass storage device like a hard disk or optical disk drive, or a solid state or semiconductor type of memory.

It is noted that the database system may be implemented in a dedicated hardware device, or in any suitable computer having the respective peripherals for entering and delivering the database data. The processing unit 11 may be constituted by the processor and memory of the computer operating according to a computer program having the respective instructions.

The processing unit is arranged for the following operations. First database data is received at the input unit. Subsequently a type of the database data is determined, and corresponding database elements are generated. The system generates one or more database elements, of the following available database elements:
an item element comprising database data;
a link element comprising a link between the item element and a further item element;
an item type element comprising type information of the item element;
a link type element comprising type information of the link element.
   The item element has a type field for connecting to an item type element, and the link element also has a type field for connecting to a link type element. A detailed example of possible fields is explained in detail later.

The user data that is received is stored as a new item element when the user data is content data for example a phone number or an address. Furthermore, the new item element may be related in a specific way to a further item element, for example the company is coupled to a person as his employer. Such relation is stored in a new link element, which holds information linking both item elements, e.g. two pointer values. The link type may connect to an item naming the link, e.g. “Employer”.

The new item element may be of a known type, for example a name of a person. The database may already contain other persons having names. The item type element for persons may be already present, and may contain the value “People”. The phone number just entered is coupled to a person via said new link element. If the phone number is a known link type it may already be stored as a link type element. However, when a new link type is introduced, e.g. the first address is to be coupled to a person, a new link type element is generated. An item type element provides a chunk of content data describing the underlying items of that type. For example an item type element having the value “phone number of”, may be coupled to the new link type element.

When a new database element is generated, an actual timestamp is included in the database element. Subsequently to including said actual timestamp, the new database element is transferred to the storage unit for storing the database element. The storage unit is further arranged for retrieving database elements. It is noted that several versions of a particular database element may be stored in the database, e.g. due to a number of updates. The processing unit is arranged for selecting an actual version of the database element in dependence of the timestamp. For example all versions of the database element may be retrieved and evaluated, and the one with the latest time stamp is selected. Alternatively the storage unit may be instructed to retrieve the database element having the most recent time stamp.

In an embodiment of the database system all versions of a database element are maintained in the database. Hence the situation of the database at a particular moment in time can be retrieved by ignoring all database elements having a later time stamp. Furthermore all changes can be undone by removing the latest version of the database element. Alternatively deletions or undo/redo operations may be entered by storing further records, e.g. by using a status field indicative of the respective operation. Advantageously any change can be reversed, e.g. for restoring to an earlier version after erroneous, unintended or malicious changes.

In a further embodiment of the database system the storage unit is a write once storage unit for storing of the database elements, usually called WORM—write once read many. For example the storage unit may be an optical disk drive recording data on a write once type of record carrier, such as a CD-R. This has the advantage that, although the database may be changed, any older version can be retrieved from the storage medium based on the time stamps. Furthermore every mutation or addition is stored and can be proven to have been entered as indicated by the time stamp. Hence a full logging of events and changes is inherently present in the database.

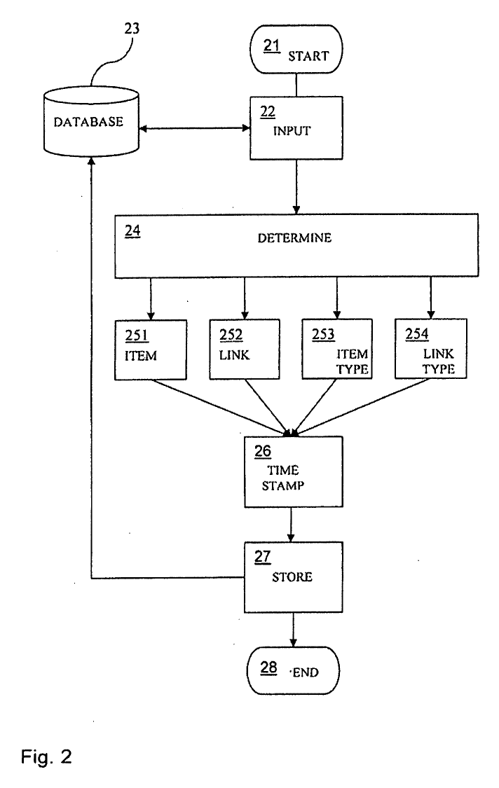

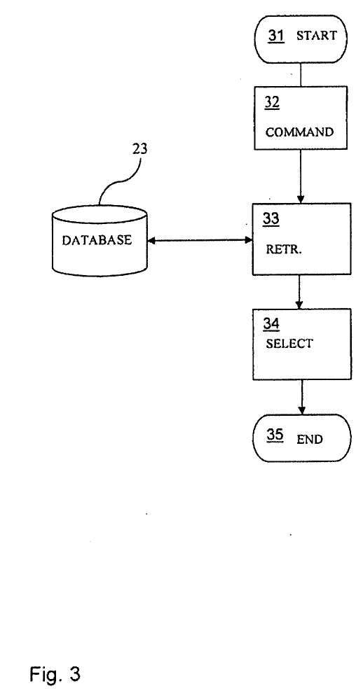

FIGS. 2 and 3 show a method of managing data in a database. FIG. 2 shows a method of storing data in a database. The method is performed in a database system, and includes the following operations. At node START 21 a database system is started. At this moment the database 23 may be empty, or may already contain database elements stored earlier, for example some item type and link type elements. At node INPUT 22 database data is received, which data is to be stored. When item type or link type elements are already available in the database 23, database data may be received according to the respective types. In a next node DETERMINE 24, it is determined which new database elements are needed to store the newly received data. One or more of the following database elements are generated in parallel nodes. In node ITEM 251 an item element comprising database data is generated; in node LINK 252 a link element comprising a link between the item element and a further item element is generated; in node ITEM TYPE 253 an item type element comprising type information of the item element is generated; and in node LINK TYPE 254 a link type element comprising type information of the link element is generated. The fields of the elements are explained with reference to FIG. 3. In a next node TIME-STAMP 26 a time stamp is generated, e.g. the actual date and time, and the timestamp is included in the database element. In node STORE 27 the database elements are stored in the database 23. At node END 28 the process is completed.

FIG. 3 shows a method of retrieving data from a database. At node START 31 a database system is started. At this moment a database already contains database elements stored earlier, according to the method above. At node COMMAND 32 a command to retrieve data is received, e.g. from a user or an application requiring data. At least one database element is retrieved as requested in the command in step RETR 33, which accesses the database 23. For the database element all versions of the specified element are read and the time stamp values are compared. In node SELECT 34 the actual version of the database element is selected in dependence of the timestamp, i.e. the most recent timestamp is detected and the corresponding database element is taken as the actual version that is currently valid. The selected database data is subsequently delivered to the user or application. At node END 35 the process is completed.

In an embodiment of the method generating the database element comprises including an identifier that identifies the database element and enables further database elements to connect to the respective database element. The identifier for example is a numerical value. The identifier provides a label for detecting the respective database element. The identifier in combination with the timestamp constitutes a unique key for the database element. Based on the identifier said retrieving of the actual version of the database element involves selecting a most recent one of all database elements having a same identifier. It is to be noted that the identifier as such is not unique, contrary to traditional relational database structures. Various database elements may have the same identifier, but will have different time stamps.

In an embodiment the process of retrieving database data involves the following steps. First a specific an item element is retrieved, e.g. based on user input a record of a user carrying a specific name as value is retrieved. Subsequently related database information is to be retrieved, e.g. to display a number of items related to said specific person. Thereto one or more link elements are retrieved. A link element includes a link that indicates between which items the link exists, e.g. two pointers or a parent identifier value and a child parent identifier value. Via the link pointer to the first retrieved item element the database is requested to retrieve some or all link items that point to or contain the specific link value of the first retrieved item. Each retrieved link item also connects to a further item element due to said link having a second pointer or identifier value. Hence for each retrieved link the respective connected further item element can be retrieved via the second link value of the retrieved link element. For example the complete data set can be delivered to an application, or the first item can now be displayed in combination with the further items that have been found via the links.

In an embodiment the process of retrieving database data involves the following steps. First a specific item element is retrieved, and the retrieved item element is analyzed to read the fields constituting the element. A specific field, the type field, indicates the nature or category of the item, by pointing to or identifying an item type element. Subsequently the corresponding item type element is retrieved in dependence of the type field in the first retrieved item element. The item type element is analyzed to read the fields constituting the element. From the item type fields the item element can be processed according to the retrieved item type element. For example the item type fields indicate that the item element is a phone number. A corresponding heading can be displayed, and possibly a set of phone numbers can be grouped, and for example displayed as a list. However, there may be no corresponding type element available in the database, e.g. due to lack of data entry or removal of such type element. The respective item element is still available and coupled to the first item element, and can be processed according to no-type criteria. For example such no-type criteria may include setting a dedicated status indicator, displaying the respective items in a specific area or color, or not displaying them directly and providing an option for the user to display such no-type items.

In an embodiment the process of retrieving database data involves the following steps. First a specific item type element is retrieved, and the retrieved item type element is analyzed to read the fields constituting the element. Next, at least one link type element comprising a link between the item type element and a further item type element is retrieved. It is to be noted that the link type element connects item type elements on a higher level, but similar to the way the link element connects two item elements. Furthermore, new database data may be received. From the link type elements that are coupled to the item type element it is known which items can be coupled to a specific instance of an item of the respective type. Hence data entry can be controlled for requesting such data items. For example a data entry screen may be shown on a display, and a user may enter new user data in fields on the screen. For each value that has been entered a new item element is generated, and a new link element coupled to the respective items when so indicated by the link type elements retrieved earlier. Hence database data is received and one or more link elements and item elements are correspondingly generated, the structure being according to the retrieved item type and link type elements. The structure may include, coupled to an item element according to the item type element, at least one further link element based on the link type element or at least one further item element based on the further item type element.

In an embodiment the database elements further include at least one higher hierarchical level, for example a third level called system level. It is noted that more levels can be allowed based on the hierarchical structure in levels. On the higher level the database elements provide information on the next lower level, e.g. the system level provides information on the type level having the item type and link type elements. The higher level database elements include:
a higher level item element comprising higher level information of a lower level item element;
a higher level link element comprising higher level information of a lower level link element.

The higher level item element has a type field for connecting to the lower level item element, and the higher level link element has a type field for connecting to a lower level link element.

In an embodiment the database system is provided with a tool for ordering database elements of a same kind. Thereto a link element is generated including a position field indicating a position with respect to further link elements of a same link type, and/or a link type element is generated including a position field indicating a position with respect to further link type elements. When a set of database is retrieved, e.g. a number items representing documents coupled to a project item in a workflow database, the document items may be ordered according to their relevance during entry, and the respective position fields in the corresponding item elements are assigned in said order of relevance. Also during retrieval the database elements such as item elements and/or item type elements may be ordered according to the position.

The values representing the position may be generated automatically, for example based on a position of entry indicated by a user, or based on a value representing the actual content of an item. A large range of values, e.g. a 6 byte hexadecimal number, may be used to allow large amounts of data to be entered in between existing database elements. New values in said range may for example be assigned halfway two existing neighbors. When no space is left, the position fields of a few neighboring database elements may be modified for shifting the neighbors into an unused part of said range.

In an embodiment the database system allows using parallel copies of the database that are operated in separate locations. For a period of time the various copies of the database are used without mutual updates, i.e. data is entered and modified independently. After such a period there is a need to apply all modifications to a main version of the database, which is usually called synchronization of the database copies. First a copy of the database is provided in a further database system. For a period of time the main database and one or more copies of the database are used simultaneously and independently. After said period of operating, the database versions, i.e. the main database and the copy of the database, are synchronized as follows. All database elements having timestamps beyond the start of said period are extracted, and inserted into each version. If a same database element has been modified twice, a conflict may arise. For example this may be resolved based on the time stamp, i.e. the most recent time stamp prevails. Other solution of resolving such conflict may include priority of certain copies (e.g. the database version operated in the headquarters of a company, or based on priority criteria included in the database elements, such as an operator identifier that indicates the user that entered the respective database element. Some user may have higher authority than others. Furthermore conflicting modifications may be rejected, or may be presented to a user or operators, e.g. to the operators that originally entered the conflicting data.

FIG. 4 shows a data model. The data model shows a practical embodiment of the database system. The left column 15 shows tables in the model, the right column 16 shows the fields in the tables. The data model has 3 levels. Each level consists of an Item table and a Link table. Items-records are linked to each other by means of Link-records. Every Link record connects a ‘Parent’ record with a ‘Child’ record, which both are Items. Items are coupled via a Type field to an Item Type record that has a Type attribute defined on a higher level. The fields as indicated in the Figure have the following definitions. Fields in Item tables:

| | |
|---|---|
| Id | Key, unique in combination with Stamp |
| Type | Refers to an Id on a higher level. Indicates the category of the |
| | record |
| ITxt | Actual content |

Fields in Link tables have the following definition:

| | |
|---|---|
| Id | Key, unique in combination with Stamp |
| Prnt | Id of an Item, the ‘Parent’ of this link |
| Chld | Id of an Item, the ‘Child’ of this link |
| PrntPos | Position number of a ‘Parent’ |
| ChldPos | Position number of a ‘Child’ |

Common fields, used in both the Item table and the Link table

| | |
|---|---|
| Stamp | Date time stamp, in ASCII format. Contains: |
| | year, month, day, hour, minute second |
| | 6 digit random number |
| | e.g.: 19991231 235959 123456 |
| | (Spaces are for readability only. 123456 represents random) |
| Status | Contains markers for deleted records. May also contain markers |
| | for undo en redo actions. |
| UserId | User that has created or changed the Item or Link |

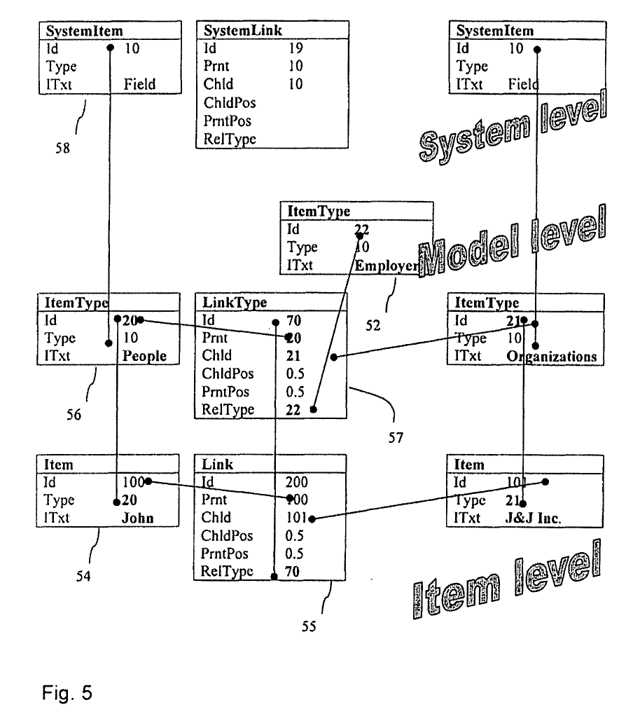

FIG. 5 shows diagram of a database. A visual representation of records is given for an example database. Various database elements, called records now, are shown on an item level, a higher level called model level and a top level called system level. An item element 54 (i.e. John) of the item type 56 (i.e. People) is coupled via type field, which item type is coupled via its type field to system item 58. A link element 55 connects item element 54 to a further item element. Thereto the link element has a parent link and a child link to a further item (i.e. J&J Inc). The link element 55 is coupled to a link type element 57 via a relation type field, having the value (=70) of the identifier of the link type element 57. The link type element 57 is coupled to an item type element via a relation type field to define the nature of the link type (i.e. Employer). The example database has the following database data:

Root
People
   Employer→ Organizations
   Address
   Phone number
Organizations
   Website
   Branche
      In the diagram of FIG. 5 the following aspect is given in detail:
People

Employer→Organizations

### The values in the diagram are representing that John works for J&J Inc:

John
   Employer→J&J Inc.
      In practice the following database elements, which represent that John works for J&J Inc, Johns address is Park Lane, and Johns phone number is 111-222 3333, may be stored:

### People

John

### Employer

J&J Inc.

### Address

Park Lane 1

### Phone number

111-222 3333

### The following sequence of events will take place when information is requested on a certain item (showing between brackets is shown what that would be for the example of John as used earlier):

Information is requested on a certain item (John)

It is being determined what type this item is (People)

It is determined which types can be linked to this type and also what type of link (relationship type) that would be (Organizations, Address, Phone number. A relationship type is only known for: Employer)

The order in which the types will be shown is determined using the position numbers of the LinkType records.

It is determined what items are linked to the item information is requested about. (J&J. Inc., Park Lane 1, 111-222 3333)

For every linked item, the type of the link is being determined (LinkType) (Employer, Address, Phone number)

The linked items are shown, sorted according to their type (The order in which the types will be shown is determined using the position numbers of the LinkType records.) Within each type, the items will be sorted according to their position number.

It is noted that the database elements represent information on various levels. The relationship between levels (SystemItem and SystemLink)—(ItemType and LinkType) is substantially identical to the relationship between levels (ItemType and LinkType)—(Item and Link). In both instances, the records in the first pair of tables describes what data can be stored in the in the can be in the second pair of tables. It is noted that self-reference (on a single level) may be allowed. For example on the lowest level, e.g. People, a link might be made, the link type being “is the boss of”.

In Edit mode, users can change (Item and Link) according to the possibilities that are defined in (ItemType and LinkType). In Model mode, users can change (ItemType and LinkType) according to the possibilities that are defined in (SystemItem and SystemLink).

It is noted that the tables for storing the database elements as described above may be implemented using existing relational database systems such as provided by Access or Oracle. Some dedicated type of operations are required for efficiently selecting the database elements based on time stamps. An example of a software language function to retrieve a most recent database element in Standard Query Language (SQL):

######### Retrieve itemrecords with highest timestamp of 2 types
######### (using the SQL92 standard)
SELECT Type, Id, ITxt, Status, Stamp
FROM item as I
WHERE Type in (‘ID1’, ‘ID2’) and
Status <> ‘R’ and
Stamp in

(SELECT MAX(Stamp) FROM item where Id=I.Id)

order by type
######### (end).

### It is noted that the above function also tests on the value of the Status field, i.e. not having the value ‘R’ indicating removed.

In the above model there are different ways of dealing with links. It is possible to specify a link on model level, as shown in FIG. 4. If the number of possible different links is small, the different option may be defined on model level. When creating a new link the predefined options may be presented in a “popup” window. For example when for People a link of the type Employer may be selectable from a popup list. Subsequently the available Organizations may be shown in a popup list.

### Schematically:

### People

John

### Employer

J&J Inc. (This is an organization)

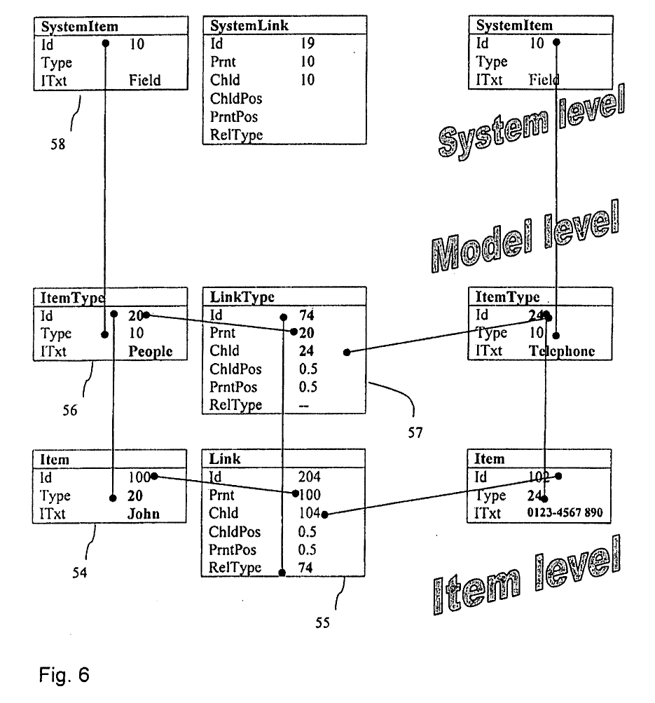

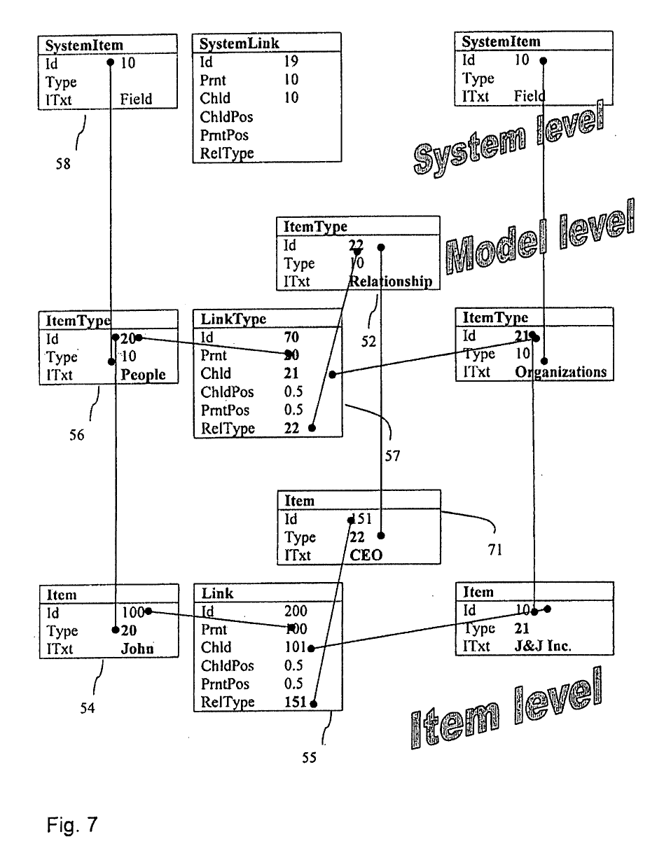

However, it is also possible to specify a link on item level as shown in FIG. 7 below, or to omit specifying the link as shown in FIG. 6. Specifying is to couple a link record to an item record (or itemtype record), whereby a name from the item record (or itemtype record) is attached to the link.

FIG. 6 shows a data model without specifying a link. The data model shows a practical embodiment of the database system similar to FIG. 5. However, the ItemType element 52 has been omitted, and the RelType field in LinkType record 57 is empty. For example, when a phone number is coupled to a person the link as such is sufficient. Hence, when the interpretation of a link is clear without further details, the link may remain unspecified. For example further notes of various natures may be added without indicating that they are notes.

FIG. 7 shows a data model which specifies a link on item level. The data model shows a practical embodiment of the database system similar to FIG. 5. However, an Item element 71 has been added, and the RelType field in Link record 55 now refers to the Item element 71. Thereby the Item element 71 provides the name (“CEO”) to the Link between the Item 54 (People=“John”) and the Item with Id 101 (Organizations=“J&J Inc”). Hence the link of a person to a company is now further defined by naming the link. In particular when the number of possible links is large, or unknown, links may be specified at item level. For example, schematically, a relation to a particular organization may be specified:

People

John

| | |
|---|---|
| Organizations | Relationship |

| | |
|---|---|
| J&J Inc. | CEO |
| Xxx Corp | Salesmanager |

This embodiment allows specifying the links on item level and/or on model level. On model level the kinds of possible links are specified by LinkType records. The kind of link depends on the value of the RelType field of the LinkType record, and of the type of the ItemType record to which the value of the RelType field points. When the RelType field is empty, the Link is not specified (see FIG. 6). When the RelType field contains a pointer, there are two options:
a) The RelType field of the Link record points to a LinkType field (see FIG. 4). The LinkType indicates the type of the link, which may further be specified by the RelType field in the LinkType record pointing to an ItemType record.
b) The RelType field of the Link record points to a Item field (see FIG. 7). The Item record directly indicates the type of the link.

The above model may be extended by a concept option, i.e. to mark proposed amendments as concepts, and optionally restrict the visibility to certain qualified users. The proposed amendments to a database are included in the database model as elements provided with a concept marker. On request, the concepts may be shown for evaluation and approval, testing and/or possible further amendments. Subsequently, all amendments, or a subset of amendments having a corresponding concept marker, may be rejected or upgraded to final by either removing or changing the concept marker, or automatically writing corresponding final update records. Such a release may be accomplished by a single user command. Releasing concepts may be reserved for users having corresponding access rights to the model, which may be different users than the author(s) of the concepts.

The concept option may be implements as follows. For each record a concept marker field is added, both to item records and link records. The concept marker field may indicate whether a field is concept or not. A general or user-specific indicator can be used to allow editors to make amendments without making use of the concept marker, which thus will be visible for others immediately.

Alternatively, the amendments will be marked as concept. The editor may choose to view the database with or without his own concept-amendments. Others may be permitted to view the database including the concept elements of the aforementioned editor depending on the implementation of the system and the rights they may or may not have to view concepts of others.

Each amendment can be attributed to a specific user, because each record contains a User-ID field, which is the reference to the user who created the record. A binary concept marker can therefore be used to track the concept-amendments of a user.

The following steps may be implemented for releasing a concept. Upon completion of a set of concept-amendments, the concept-amendments must be accepted or rejected. Acceptance of a set of concept amendments, may be done by removing the concept marker for each item record and each link record involved in the set of concept. Alternatively, acceptance of a set of concept-amendments, may be done by adding similar records, but now not marked as concept. Furthermore, the User-ID may be different depending on which user that does the ‘acceptance’ or ‘release’ of the concept. The timestamp of the newly written record may be different too.

Rejection of a concept is a necessary step if the implementation is done with a binary concept marker. If this step is not taken, subsequent concepts form the same user will include the earlier concept. Rejection of a concept may be done by removing all records of the concept of the user. Alternatively, more or less similar records may be added as follows:

For item elements or link elements that are introduced in the concept at hand, records should be added that have the effect of these elements. These records have to be marked as concept and have the same User-ID.

For item elements or link elements that were introduced before the concept, and that have been amended within the concept, records should be added that have the effect of undoing these amendments. These records have to be marked as concept and have the same User-ID.

In a further embodiment of the concept marker a concept status identifier for the concept called Concept-ID is used. Instead of using a general (binary) concept marker, concepts may be marked by the Concept-ID that links to data that contains more status information on that concept. This allows individual users to work on distinct sets of concept-amendments. Concept status information may include:
concept status level, (e.g. open, rejected, accepted)
concept editors, who may edit a concept
concept viewers, who may view a concept
   Viewing (e.g. for the purpose of testing) may involve several concepts at the same time. This allows for the assessment the impact of combinations of concepts. Editors may choose to work on a certain concept. Their amendments will be marked to indicate that they are a part of that concept. They may choose to be able to view data from other concepts while they are working on their concept.

It is noted that the concept extension allows also concept-amendments of the data structure. Concept markers can be used at model level as well as item level. When used at model level, amendments in the structure of the data can be assessed against current data and implementing (accepting) the amendments in the data structure can be done in the aforementioned way. Proposing and testing amendments of the data structure will most likely involve three sets of records:

1) Data structure elements itself. These are the amendments in records at the model level (implemented in the ItemType table and LinkType table)

### 2) Content of new parts of the data structure that has to be preserved on accepting the concept (implemented in the Item table en Link table). Typical example is data that will be used to populate “popup” lists in the new data structure.

3) Test data that has to be discarded on accepting the concept (stored in the Item table en Link table). Upon accepting a proposal, test data may not be included in the acceptance. There are two ways of getting that done:

### A) Test data can be removed manually; or

B) Alternatively, two Concept-IDs may be used. One Concept-ID is used for the data structure and the amendments in the content of new parts of the data structure that have to be preserved on accepting the concept. The other Concept-ID is used for the test data. The former can be accepted in a way described above, the latter may be rejected or ignored.

In the above proposing amendments in the data structure (a concept structure) and testing these amendments are treated as distinct steps. Testing can be performed without access to the concept in which the amendments in the data structure are defined. Different tests can be performed simultaneously, by using different Concept-IDs

Although the invention has been explained mainly by embodiments using a single computer system, the database of the invention may be implemented on any local computer, such as a personal computer, a mobile computer like a laptop, or personal digital assistant, or on a server computer connected via a network like the internet.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the invention is not limited to the embodiments, and lies in each and every novel feature or combination of features described above.

1. Method of managing data in a database in a database system, the method comprising
receiving database data to be stored,
generating at least one database element out of the following database elements:
an item element comprising database data;
a link element comprising a link between the item element and a further item element;
an item type element comprising type information of the item element;
a link type element comprising type information of the link element;
the item element comprising a type field for connecting to an item type element, the link element comprising a type field for connecting to a link type element,
including an actual timestamp in the database element and subsequently storing the database element, and
retrieving an actual version of the database element in dependence of the timestamp.

2. Method as claimed in claim 1, wherein generating the database element comprises including an identifier that identifies the database element and enables further database elements to connect to the respective database element,
the identifier in combination with the timestamp constituting a unique key for the database element.

3. Method as claimed in claim 2, wherein said retrieving of the actual version of the database element involves
selecting a most recent one of all database elements having a same identifier.

4. Method as claimed in claim 1, the method comprising
retrieving an item element,
retrieving at least one link element coupled via the link to the retrieved item element, and
retrieving at least one further item element via the link of the retrieved link element.

5. Method as claimed in claim 1, the method comprising
retrieving an item element,
detecting a type field in the retrieved item element,
retrieving a corresponding item type element in dependence of the type field in the retrieved item element,
processing the item element according to the retrieved item type element,
and, in the event that the database has no corresponding type element, processing the item element according to no-type criteria.

6. Method as claimed in claim 1, wherein said processing comprises
retrieving an item type element,
retrieving at least one link type element comprising a link between the item type element and a further item type element, and
receiving database data for generating, coupled to an item element according to the item type element, at least one further link element based on the link type element or at least one further item element based on the further item type element.

7. Method as claimed in claim 1, wherein said database elements further comprise at least one higher hierarchical level, including:
a higher level item element comprising higher level information of a lower level item element;
a higher level link element comprising higher level information of a lower level link element;
the higher level item element comprising a type field for connecting to the lower level item element,
the higher level link element comprising a type field for connecting to a lower level link element.

8. Method as claimed in claim 1, wherein
generating said link element comprises including a position field indicating a position with respect to further link elements of a same link type, and/or
generating said link type element comprises including a position field indicating a position with respect to further link type elements,
and the method comprises ordering item elements and/or item type elements according to the position.

9. Method as claimed in claim 1, wherein the method comprises
providing a copy of the database in a further database system,
operating for a period the database and the copy of the database simultaneously and independently,
synchronizing, after said period of operating, the database and the copy of the database in dependence of the timestamps.

10. Method as claimed in claim 1, wherein the method comprises
providing at least one of the elements of the database system with a concept marker for indicating a concept status.

11. Database system for managing data in a database, the system comprising
input means for receiving database data to be stored,
processing means for
generating at least one database element out of the following database elements:
an item element comprising database data;
a link element comprising a link between the item element and a further item element;
an item type element comprising type information of the item element;
a link type element comprising type information of the link element;
the item element comprising a type field for connecting to an item type element, the link element comprising a type field for connecting to a link type element, and
including an actual timestamp in the database element, and
storage means for, subsequent to including said actual timestamp, storing the database element and for retrieving database elements, the processing means being arranged for selecting an actual version of the database element in dependence of the timestamp.

12. System as claimed in claim 11, wherein the storage means comprise a write once storage unit for storing of the database element.

13. Computer program product for managing data in a database in a database system, the product comprising a program of instructions, wherein the program is operative to cause a processor to perform the method as claimed in claim 1.

14. Computer program product for managing data in a database in a database system, the product comprising a program of instructions, wherein the program is operative to cause a processor to perform the method as claimed in claim 2.

15. Computer program product for managing data in a database in a database system, the product comprising a program of instructions, wherein the program is operative to cause a processor to perform the method as claimed in claim 4.

16. Computer program product for managing data in a database in a database system, the product comprising a program of instructions, wherein the program is operative to cause a processor to perform the method as claimed in claim 5.

17. Computer program product for managing data in a database in a database system, the product comprising a program of instructions, wherein the program is operative to cause a processor to perform the method as claimed in claim 6.

18. Computer program product for managing data in a database in a database system, the product comprising a program of instructions, wherein the program is operative to cause a processor to perform the method as claimed in claim 7.

19. Computer program product for managing data in a database in a database system, the product comprising a program of instructions, wherein the program is operative to cause a processor to perform the method as claimed in claim 8.

20. Computer program product for managing data in a database in a database system, the product comprising a program of instructions, wherein the program is operative to cause a processor to perform the method as claimed in claim 9.

21. Computer program product for managing data in a database in a database system, the product comprising a program of instructions, wherein the program is operative to cause a processor to perform the method as claimed in claim 10.
